(19) United States
(12) Patent Application Publication
(10) Pub. No.: US 2019/0251611 A1
(43) Pub. Date: Aug. 15, 2019

(54) Contextual Restaurant Ordering System

(71) Applicant: Novo Labs, Inc., Dallas, TX (US)

(72) Inventors: Clinton John Coleman, Dallas, TX (US); Jeffrey Demetrius Loukas, Dallas, TX (US)

(21) Appl. No.: 16/393,239

(22) Filed: Apr. 24, 2019

Related U.S. Application Data
(63) Continuation of application No. 16/148,356, filed on Oct. 1, 2018.
(60) Provisional application No. 62/568,373, filed on Oct. 5, 2017.

(51) Int. Cl. G06Q 30/06

(52) U.S. Cl. CPC G06Q 30/0613; G06Q 50/12; G06Q 30/0633

(57) ABSTRACT

Methods and systems related to an automated process for dynamically interacting with customers in a customer-facing system, such as a drive-thru, is described herein. In one example method, a vehicle is identified as present in an ordering area of a first entity. The vehicle can be associated with a customer about to place an order or otherwise interact with the first entity. An automatic determination can be made whether to initiate an interaction with the customer in a first mode or a second mode, where the first mode represents an automated interaction mode and the second mode represents a manual interaction with at least one human agent of the first entity. The determination can be based on at least one of a current context of the customer or the first entity. Based on the determination, the initial interaction can be automatically routed to the determined first or second mode.

### CROSS REFERENCE TO RELATED APPLICATIONS

This application is a continuation application of and claims priority to U.S. application Ser. No. 16/148,356, filed on Oct. 1, 2018, which claims the benefit of U.S. Provisional Application No. 62/568,373, filed Oct. 5, 2017, the entire contents of which are hereby expressly incorporated by reference herein in their entirety.

### TECHNICAL FIELD

The present disclosure relates to an automated system for automatically interacting with customers in a restaurant setting.

### BACKGROUND

Natural language processing (“NLP”) represents the field of studies and advancement used to allow computer and automated system understanding and manipulation of human language. In other words, NLP is a way for computers to analyze, understand, and derive meaning and intent from identified human language interactions. NLP can be used in machine or conversational interfaces to replace the need for another human to be interacting in real-time with a customer or user.

Today's natural language processing services are usually sufficient to process the type of speech commonly used by in user or customer transactions. Users continue to become increasingly familiar with verbally interacting with machine interfaces in other aspects of their life, such as the popular Ski® service from Apple Inc. and the Alexa® service from Amazon.com, Inc., among others.

### SUMMARY

The present disclosure involves systems, software, and computer implemented methods for automatically interacting with customers at an ordering area, where the ordering area can be remote from one or more human agents. The automatic interaction can include a determination of whether an automated interaction should be performed or whether the interaction requires a manual interaction process. A first example system includes identifying a vehicle present in an ordering area of a first entity, the vehicle associated with a customer. Automatically and without user input, a determination can be made whether to initiate an interaction with the identified customer in a first mode or a second mode, where the first mode represents an automated interaction mode and the second mode represents a manual interaction with at least one human agent of the first entity. The determination can be based on at least one of a current context of the customer or a current context of the first entity. Once determined, the initial interaction with the customer is automatically routed to the determined first or second mode.

Implementations can optionally include one or more of the following features.

In some instances, where the determined mode is the first mode, and after initiating the interaction with the customer in the first mode, an updated context associated with at least one of the customer or the first entity is dynamically determined. Based on that updated context, the interaction with the customer can be re-routed to the second mode for further interactions based on the updated context.

In some of those instances, at least some of the human agents of the first entity are provided with textual, visual, or audio information regarding the status of the interaction with the customer upon the re-routing of the interaction.

In some of those instances, at least some of the human agents of the first entity are provided with textual, visual, or audio information regarding the status of the interaction with the customer during the interactions with the identified customer in the first mode.

In some of those instances, dynamically determining the updated context includes identifying an interaction from at least one human agent associated with a re-routing instruction during an interaction with the identified customer while the initial interaction is being performed. In response to the interaction from the at least one human agent, the interaction is re-routed to the second mode.

In some of those instances, dynamically determining the updated context includes, after routing the initial interaction with the customer to the first mode, determining an identification of the customer. A user profile associated with the identified customer can be accessed, and, in response to determining that the user profile includes a preference for the second mode, re-routing the interaction with the identified customer to the second mode for further interactions.

In some of those instances, dynamically determining the updated context includes, after routing the initial interaction with the customer to the first mode, identifying a non-standard interaction with the customer via the automatic interaction mode. In response to identifying the non-standard interaction with the customer via the automatic interaction mode, the interaction can be re-routed with the identified customer to the second mode for further interactions.

In some instances, where the determined mode for the initial interaction is the first mode, the content of the automated interaction with the customer may be modified based upon contextual information specific to the customer or a generic profile of the customer.

In some instances, where the determination is based on a current context of the customer, the current context of the customer used in the determination may include an identification of a customer using at least one sensor associated with the ordering area of the first entity. In some of those instances, the identification of the customer may be based on a computer-based and automatic visual identification of the customer based on a license plate analysis of the vehicle. In other instances, the identification of the customer may include identifying a user profile associated with the customer, where the user profile is associated with a stored customer preference identifying an automatic or a manual interaction preference. In some of those instances, the stored customer preference may be based at least in part on at least one prior interaction with the first entity.

In some instances, the dynamic determination can be based on a current context of the first entity, where the current context of the first entity comprises a technical analysis of a system associated with the automated interaction mode. In those instances, the initial interaction can be automatically routed to the second mode based on a result of a technical analysis of the system associated with the automated interaction mode.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system associated with the automated ordering and interaction environment in a drive-thru system implementation.

FIG. 2 is a flowchart illustrating an example set of operations associated with an automated ordering and interaction process in one example implementation.

FIG. 3 is a flow diagram of an example method for operating an automated ordering process in one implementation.

### DETAILED DESCRIPTION

The present disclosure describes, in one implementation, an automated system for a restaurant, pharmacy, convenience store, grocery stores, or other business or entity with a “drive-thru” or “drive-in” lane or similar system to take and process customer orders while those customers are in the “drive-thru” lane or area or are otherwise remote from the in-person ordering or customer interaction location. Further, while described with relation to a vehicle throughout, variations of the present solution can be used in situations where customers interact at a particular kiosk associated with a provider, including in-interactive kiosks or computer systems, such as those found inside of restaurants, retail stores or inside of pharmacies, among others. In other words, the described interactions with a customer may occur at any suitable computer kiosk, device, or system that is not located in the immediate vicinity of the business's human agents. The described system interacts with customers using voice input from the customers and output interfaces that allow the customers to place and review orders conversationally without assistance from a human agent. The system allows customers to order in the same manner as they would place an order if speaking to a human restaurant worker.

While existing NLP services continue to improve, on occasion, the customer's behavior and/or the ordering environment may preclude the automated system from smoothly completing the ordering process. For example, ambient or background noise during an interaction may not allow the system to complete clear communications, while in other instances, a customer's voice level, vocal dynamics, speech patterns, or accent may cause issues with the system. Furthermore, the restaurant may lose connectivity unexpectedly with the automated ordering system, or the restaurant's managers periodically may decide for other business reasons to route the ordering process to human agents. In some instances, the customer can be identified during or prior to an interaction based on any number of parameters, including facial recognition, license plate identification, voice recognition, radio frequency identification (RFID) means, or other uses. The customer themselves may be known to require or prefer a manual ordering environment instead of an automated one, and can be routed for the interaction to a manual process. Alternatively, an initial automated process may be modified after applying a rule set used to determine if an identified customer is to be moved or transferred to a manual interaction by lowering the threshold or requirements needed to trigger the transfer during an interaction. In these situations, the ability to quickly re-route the ordering process to the restaurant's human agents at the restaurant site or at a remote location at which human agents are available is highly desirable, and can alleviate issues associated with a purely automated interaction process.

Such a system as described herein can find significant benefits in the current environment. The cost of employing workers has continued to rise in recent years, causing operators and business owners to evaluate alterative for improving the labor efficiency of their operations. The present solution can allow, in some cases, a reduction of workers by the introduction of the automated systems. Further, the present system allows interactions with customers to be enhanced based on known customer information (e.g., based on customer-specific information, based on customer demographic information, based on a vehicle associated with the customer, etc.) and particular insight and data to enhance and attempt to optimize interactions, orders, and service experiences. In current solutions, workers typically do not modify the nature of their interaction with drive-thru customers and instead take orders in the same manner from every customer. Further, the workers typically are not provided any information that would allow them optimize the value of an order or the customer's service experience. Using the large amount of data regarding historical transactions gathered by businesses that can apply the present solution, specific historical transactions with specific customers can be considered and used by automated systems in guiding customer interactions. Additional external data, such as the weather conditions or season of the year, also may be considered and used by automated systems in guiding customer interactions.

In addition to the ability to allow customers to interact and submit orders in an automated manner, the present solution provides a failover and/or a transfer feature allowing the system to automatically route the management of a particular customer interaction to human agents at (or representing) the business in response to the automated system not being available or if the interaction with a customer is not progressing to a completed order in a satisfactory manner. A business manager or computer algorithm may also determine in advance if and when orders are to be taken by the automated system or by human agents at the restaurant site. Any suitable number of factors and parameters can be employed to (1) initially determine whether an automated or manual process should be initiated for a particular interaction and (2) determine, after initiation of an automated interaction process, whether the automated interaction process should be transferred to a manual operator or agent and continued via the manual processing operations.

The present solution provides advantages including those described above. First, the solution reduces the manual labor required to take customer orders from a business drive-thru or other remote entry point while providing customers with a pleasing ordering experience. The present solutions further reduce the need for a business's workers to manually respond to every customer at the drive-thru. In restaurant and drive-thru implementations, the present solution provides a drive-thru ordering system that allows the interaction with a customer to be modified and optimized based upon a variety of information about the customer's prior orders, the orders of similar customers, and the customer's current order. Further, while providing an automated ordering solution, the present disclosure provides mechanisms that ensure businesses maintain the ability to continue taking orders and proceeding with interactions from drive-thru customers in a variety of recovery scenarios where the automated system is no longer functioning, is unavailable, is determined to be inadequate, or receives an indication from a human agent monitoring an ongoing interaction to move the process to a manual, or person-to-person interaction. Further, the described systems provide the ability to quickly re-route the ordering process from an automated interface to the business's human agents in the event a decision, whether automatically or manual determined, is made to switch.

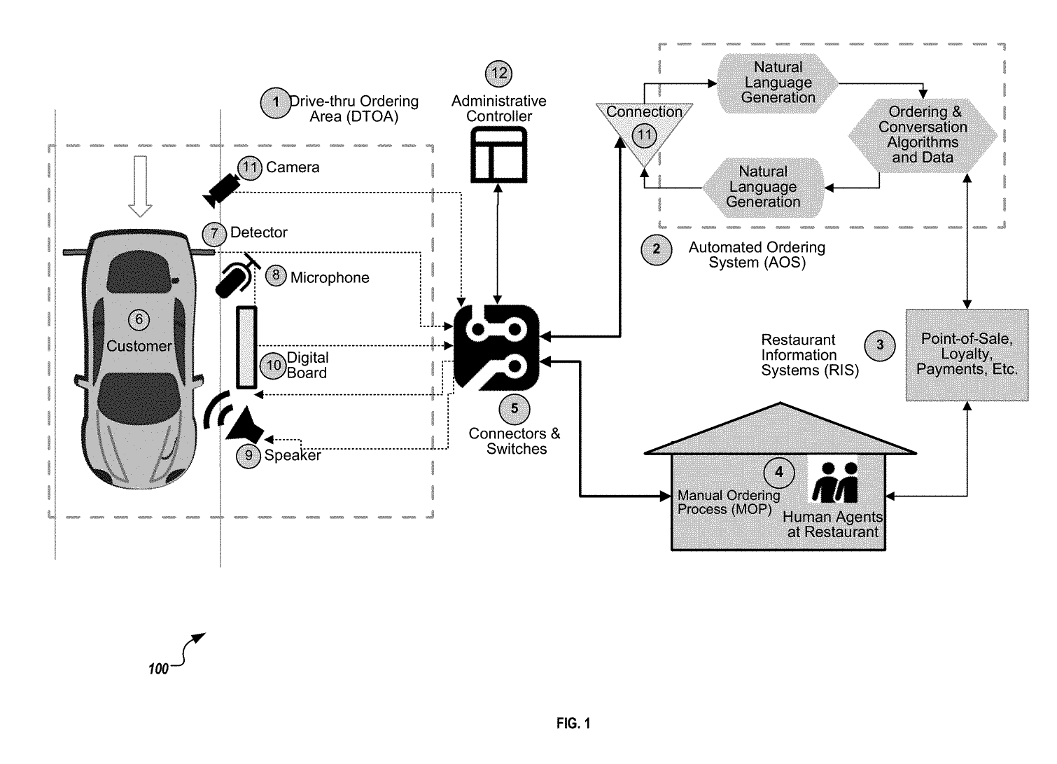

Turning to the illustrated example implementation, FIG. 1 is a block diagram illustrating an example system 100 associated with the automated ordering and interaction environment in a drive-thru system implementation. As illustrated, the system 100 is described in relation to a restaurant enabled with an implementation of the solutions described herein. The illustration is not meant to be limiting, and can be applied to non-restaurant solutions in other instances, such as retail stores, pharmacies, banks, and other suitable systems or businesses.

In particular, a restaurant is illustrated that serves food and/or beverages, and is associated with at least one designated area for purposes of allowing customers to place orders for food or beverages while remaining in their vehicle, which generally is referred to in the restaurant industry as a “drive-through” or “drive-in” or, colloquially, as a “drive-thru” area.

In the illustrated solution, a customer 6 enters this drive-thru ordering area (DTOA) 1 by driving their vehicle to one of the lanes or spaces that is designated by signage. A restaurant may have more than one DTOA 1 at a single location, which may allow orders to be taken from more than one customer at a time. Further, the DTOA 1 may be a “pull in” drive-thru (e.g., where orders are taken at a designated parking space and are then delivered to the vehicle by a mobile employee) or may be a “pull through” drive-thru (e.g., order is placed at the DTOA 1 and the customer drives to a window or other area to receive the order) without departing from the solution.

The DTOA 1 includes certain electronic devices in the example implementation. As illustrated, the DTOA 1 includes at least one detector 7, at least one microphone 8, at least one speaker 9, at least one digital board 10, and at least one camera 11. The detectors 7 may be any device or sensor operable to sense or otherwise detect a customer's presence within the DTOA 1. The detectors 7 may operate or be associated with one or more magnetic, sonic, pressure-based, audible, or optical sensors, or any suitable combination thereof. In some instances, some detectors 7 (e.g., a camera 11) may be used to identify particular characteristics about the customer 6 during or before the customer 6 entrance into the DTOA 1, as well as before or during interactions.

The at least one microphone 8 is used to receive and transduce audible expressions from customers associated with the order interactions being performed, including customer questions or actions outside of the particular ordering transaction. In some instances, the at least one microphone 8 can identify levels of outside noise used to determine the likelihood of success of an automated natural language processing process. Where the identified noise level exceeds a predetermined threshold, or otherwise renders an ongoing interaction unsatisfactory for automated interactions, a transfer or failover can be performed. In some instances, a customer's identity can be determined, at least in part, from voice input captured at the at least one microphone 8 during the interactions (e.g., through voice analysis).

At least one speaker 9 is used to produce audible messages to customers, including greetings upon arrival and interactions during and after the ordering interactions are performed.

The DTOA 1 also may optionally include one or more digital boards 10 that visually display information to customers, such as a graphical user interface related to or providing feedback as to the ordering operations. In some instances, the digital boards 10 may present or provide a visualization or area related to available items for purchase, current promotions, and other information of interest to customers 6. In some instances, at least a portion of the digital board 10 may be static, or represent a non-dynamic set of information. In those instances, the digital board 10 may include a dynamic or updating portion where order-related information, confirmations, and other relevant information can be presented, including recommendations offered after a particular customer's identity is determined. In instances where an order is received and processed, the digital board 10 may present the updated items included in the order to provide visual feedback to the customer 6 regarding the interaction.

At least one camera 11 can be operable to monitor and capture actions at the DTOA 1, including detecting a new customer arriving at the DTOA 1, and/or to capture the customer's license plate number, facial features, or other images for purposes of uniquely identifying the particular customer 6 associated with an interaction, and/or to capture an image of the customer's vehicle or person for purposes of generally classifying the customer. The camera 11, as well as any other component, may be connected to one or more computing systems, where records and data files on one or more prior customers may be stored in memory (either local to the system 100 or remote therefrom). Information captured by the camera 11 can be provided to the computing systems, and a customer can be identified based on existing stored information, such as by matching a picture of a customer, matching a license plate of a customer, scanning a loyalty or registered card associated with a customer, etc. Using the identified customer's information, a determination of whether to initially proceed in an automated or manual process can be determined, which can include whether a prior attempt at an automated solution in a previous interaction was successful, whether a customer-specific set of preferences, whether inferred or explicitly defined, approve use of the automated process, and any other suitable determination.

In some instances, the microphone 8 or camera 11 may serve as the detector 7, or may be used in combination with one or more other devices or components to perform the operations of the detector 7. The microphone 8, camera 11, and/or detector 7 may be used during the operations of the system to identify particular parameters necessary to determine whether an automated or manual ordering process should be used, including customer-specific determinations based on prior interactions, customer preferences, or both. The determinations can be performed prior to any interaction occurring, such as when a particular customer 6 arrives to the DTOA 1, as well as during an on-going interaction. Different rule sets and metrics may be applied in different scenarios, and may trigger a change from one type of interaction to another, where determined necessary or otherwise advantageous.

The Automated Ordering System (AOS) 2, as illustrated, is comprised of (a) a Natural Language Understanding (NLU) component that converts human speech to transcribed text and intents, (b) a Natural Language Generation (NLG) component that converts text to audible voice speech, (c) data (not illustrated) relating to the current customer interaction, current or historical information from the Restaurant Information System (RIS) 3, and information from other external data services; and (d) a set of ordering and conversation algorithms that process the inputs from the NLU component, the data obtained from the RIS 3, and a set of AOS rules used to determine or select the next action to be taken by the AOS 2. The AOS 2 can then transmit outputs to the NLG and, if applicable, to the RIS 3 and administrative controller 12. The AOS components operate through software executing, via one or more processors, on computers and/or computing devices located on or at the restaurant site or at one or more remote sites, which may include remote computing environments hosted by third parties, the restaurant, or the AOS vendor. The AOS 2 is connected to the other components by wired or wireless electronic communication, such as an internet connection.

The RIS 3 is comprised of software and computer-based systems that the restaurant uses to manage and execute transactions with customers. The RIS 3 can be a proprietary set of software and systems, or may be a commonly-used combination of systems used in certain industries to allow operations of the restaurant in the current illustration to operate. Similar or different software systems may be used in other instances. The RIS 3 can include at least one computer-based and/or software-based point-of-sale (POS) system that allows for the manual entry of orders, executes and records transactions, and can include a computer-based interface for the restaurant's human agents. The RIS 3 also may include a customer loyalty or rewards system that tracks transactions with specific customers, a restaurant menu and pricing management system, a kitchen process management system, and a separate electronic payment processing system, among others. Each of the RIS components may be connected by wired or wireless electronic communications or networks to other RIS components (e.g., the POS may be connected to the loyalty system, etc.) or to components of the DTOA (e.g., the POS may be electronically connected to the digital board 10). The AOS 2 is connected to one or more of the RIS components by wired or wireless means of electronic communication, such as an internet connection.

As illustrated, the restaurant can include and/or provide a manual order process (MOP) system 4 for human agents to handle orders from drive-thru customers in a manner that is consistent with typical manual drive-thru ordering processes throughout the restaurant industry. Human agents at the restaurant site are responsible for the primary operation of the MOP 4. Optionally, the restaurant may utilize human agents located at a remote site and interacting with the restaurant via telephony, internet, or other communication connection to handle and manage the ordering process as part of the MOP 4. The human agents interact with the POS and other components of the RIS 3 through computer interfaces (such as a point-of-sale computer terminal) and electronic devices (such as an electronic payment processing terminal). The MOP 4 includes the ability for human agents at the restaurant site to interact with a customer 6 in the DTOA 1 by interfacing with the microphone 8, speaker 9 and detector 7 through wired or wireless communication equipment (i.e. headsets, etc.), telephony communication, and/or computer software, which equipment or software may include the ability to record and play back audio to the speaker 9. In some instances, even where the AOS 2 is triggered to start an interaction, human agents may be listening in or providing ongoing information related to an interaction, such as through headphones worn by one or more agents, or through a listing of interactions performed so far. In some instances, contextual information about the interactions with the particular customer may only be presented to the human agents in response to a transfer or failover to the MOP 4.

In implementations utilizing one or more cameras 11, at least one of the cameras 11 can be connected to a local or remote computer and storage device for digitally storing and processing the captured images or video. The AOS 2 may process the images for purposes of converting an image of the customer vehicle's license plate into the text of the license plate number using machine vision algorithms. This text may be stored as data and used to identify particular customers and associate that vehicle with previous transactions recorded in the data, wherein the association may then be used by the ordering & conversation algorithms to personalize the interaction with the customer 6. The images also may be displayed to the human agents in the MOP 4. In some instances, captured images or video from the cameras 11 may be used to identify a current mood level of the customer 6, the identity of the customer 6 (e.g., using facial recognition techniques), or to otherwise identify unique or general aspects of the customer for use in analyzing the current and future interactions and transactions. Such information can be used to determine whether to use or continue to use an automated ordering process as well as to identify customer-specific actions to be taken during the interactions.

The DTOA 1 and its equipment and systems can be connected by wired or wireless electronic communication means to the AOS 2 and MOP 4 via one or more connectors and switches 5. The connectors 5 provide a connection to the software or electronic devices utilized in the DTOA 1, AOS 2, and MOP 4 by means of a wired electronic connection, a wireless communication device, or by means of networked electronic communication, such as an internet connection. The switches 5 may be physical (e.g., electrical or mechanical) or virtual (e.g., software) switches that allow for communications and ordering management to be provided to either the AOS 2 or the MOP 4. In one example, the switches 5 can utilize one or more mechanical switch contacts or solid-state gate circuits that are actuated by software executing on a local microprocessor (e.g., firmware) and/or an electric current. Certain functions of the switches 5 also may be possible by mechanical manipulation by a human agent (e.g., from inside the restaurant). Actuating the switches 5 routes electric communication signals between the connectors 5. For instance, the connectors and switches 5 can be configured and actuated to achieve one or more of the following outcomes:
a. Route the input to the digital board 10 to originate from either (i) the MOP 4 or the RIS 3 (e.g., which may include a connection to the POS) or (ii) from the AOS 2.
b. Route the input from the microphone 8 and/or the detector 7 to terminate at either (i) the MOP 4 (including local or remote human agents) or (ii) the AOS 2.
c. Route the input from the microphone 8 and/or detector 7 to be received by both the AOS 2 and the MOP 4, such that either or both of the AOS 2 or human agents may monitor the inputs from the DTOA equipment.
d. Route the input to the speaker 9 originating from the human agents in the MOP to be received by both the speaker 9 and the AOS 2, such that the AOS 2 may monitor the human agents' voice communication to the customer 6.
e. For a restaurant with dual or multiple DTOAs, independently control the switch 5 for each DTOA 1 to allow, for instance, one DTOA to be controlled by the AOS 2 while another DTOA is controlled by human agents in the MOP 4.

The system may include multiple connectors and switches 5 located at different area of the restaurant site or at a remote site. The connectors and/or switches 5 may be integrated into the electronic devices or software that operate the devices that comprise the DTOA 1, AOS 2, RIS 3, and/or MOP 4.

In some instances, the switches 5 can be controlled by electronic signals and/or computer instructions provided by an administrative controller 12 that is connected to the switches 5 by wired or wireless means of electronic communication, which may include an internet connection. The administrative controller 12 is a computer software system that operates on one or more computers located at the restaurant site and/or remotely and can receive instructions from the restaurant's local or remote human agents through a computer interface. The administrative controller's 12 signals can actuate the switches 5 in various configurations. For instance, the human agent can interact with the administrative controller's 12 interface to determine if orders originating from customers at the DTOA 1 shall be taken (a) manually by human agents as part of the MOP 4 or (b) by the AOS 2.

The administrative controller 12 also may communicate with, and receive instructions from, the AOS 2. The switches 5 also may be controlled directly by the AOS 2 through a wired or wireless means of electronic communication.

The ordering and conversation algorithms, which may include machine learning models, are programmed to select actions to accurately process the customer's order without any input or monitoring by a human agent. The ordering and conversation algorithms also may selection actions with the intent of optimizing the customer's ordering experience and/or maximizing the value of the order to the restaurant. The algorithms are programmed with specific rules on what action to select in certain circumstances, but also may utilize machine learning models to determine the optimal action given the order status and inputs from the AOS 2. An example set of potential actions included in the algorithms include:
Generate a voice response through the NLG to advance the ordering process to the next step;
Generate a voice response through the NLG to seek clarification or modification of the Customer's statement;
Generate a voice response through the NLG to provide the customer 6 with information or otherwise respond to a question from the customer 6;
Generate text or other content to be displayed on the digital board 10;
Continue to process the input from the microphone 8 or NLU;
Retrieve information from or store information within the data associated with a particular customer, other customers, or recent prior transactions;
Query the RIS 3 to gather more data regarding the customer 6 or the other order attributes;
Transmit information to the RIS 3 regarding the customer's order; and
Transmit a signal to either the administrative controller 12 to actuate the switches 5 or directly to the switches 5.

The data is stored in a computer-readable format at remote or local sites. The data is populated by information regarding or associated with the prior activities of the AOS 2 and a current state of the interaction with the customer. The data also may include data received from the RIS 3, such as the restaurant's menu, details of historical transactions, current and historical information regarding the status of the restaurant's operations, and information regarding specific customers of the restaurant, including one or more particular customer(s) associated with a current interaction, as well as similarly situated or related customers. External sources of information that also may be sources of data for the algorithms, and can include weather information, a calendar of notable events and holidays, road traffic conditions (e.g., based on nearby traffic identifying an expected increase or decrease in business), social media activities (e.g., information on ongoing or scheduled events near the business), or other information inputted by the restaurant's human agents.

The ordering and conversation algorithms may alter actions and the conversational response provided to a customer based upon specific characteristics of the data. In some instances, prior orders and interaction details associated with an identified customer (e.g., if the customer identifies himself or herself, is identified by license plate recognition, or is otherwise identified, such as by voice or facial recognition) can be used to determine one or more recommendations associated with an order, one or more likely orders to shape or estimate received input (e.g., where voice input is not clear or decisive as received from microphone 8), a need or recommendation to transfer the interaction with the customer from an automated interaction to the MOP 4 for further processing, as well as other suitable determinations. In an ongoing interaction, the items included in a current order may be used to identify one or more items to recommend or likely items to be requested, as well as particular actions or clarifications to be made. The time of day, day of the week, or other time or day may be used to determine the next action in the ordering process. Current weather conditions or a seasonal time of year can be used to identify or recommend particular items (e.g., a warm drink or option on relatively cold days or times, or a cool drink on relatively warmer days or times). In some instances, an analysis of similar customers based on the current customer's current order or other characteristics personal to the customer (e.g., type of car, type of voice (e.g., male or female), current order or characteristics of the current order) can be compared to other customers and customer orders. Any number of other parameters can be identified or determined to modify the operations of the described system.

Examples of different conversational responses that the ordering and conversation algorithm could provide to a customer 6 based on the data related to the current transaction, the customer's particular preferences, the external factors, and any other suitable parameter can be defined in one or more rule sets or other instructions identifying particular actions to be taken. Examples can include suggesting one or more menu items for the current customer 6 to purchase, offering the customer 6 a promotional discount on certain menu items, providing information regarding the customer's previous order(s) and allowing the customer to reorder those menu items at the beginning of the interaction, alerting the customer 6 to items that were recently added to the menu or preferred by other customers with similar customer profiles or preferences, and suggesting other modifications to the order or confirming certain aspects of the order, among others.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

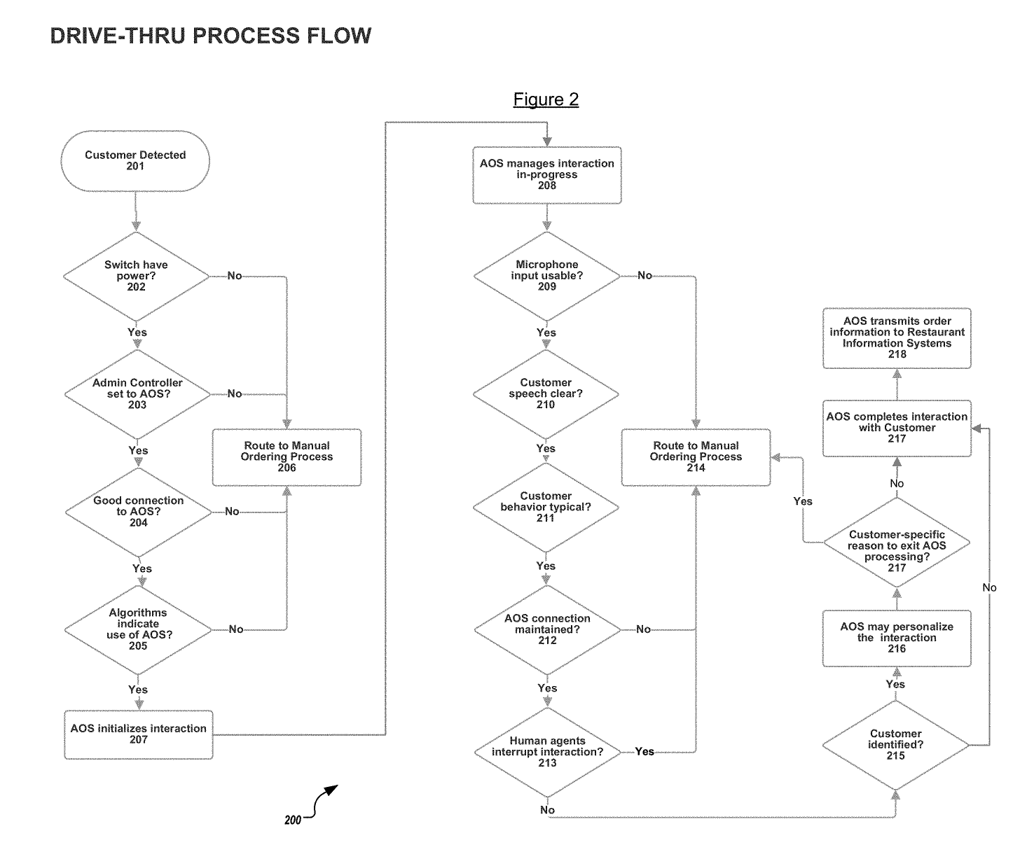

FIG. 2 is a flowchart illustrating an example set of operations 200 associated with an automated ordering and interaction process. It will be understood that method 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute method 300. In some implementations, the method 300 and related methods are executed by one or more components of the system 100 described above with respect to FIG. 1.

At 201, a customer 6 drives their car to a particular DTOA 1, where the particular DTOA 1 may be one of a plurality of DTOAs in some instances. Upon arrival, at least one detector 7 can sense the customer's presence at the particular DTOA 1.

The settings of a switch or multiple switches 5 determine if the ordering process with the customer is to be initiated and managed by the human agents in the MOP 4 or by the AOS 2. The settings of the switch 5 can be determined by input from the administrative controller 12 or the AOS 5, as well as the internal firmware of the switch 5. In some instances, the determination may be made based on the particular customer 6 (e.g., based on a license plate identified for a customer, a set of customer preferences can be determined, or information on prior interactions), a particular customer profile associated with the customer 6, or characteristics of the particular customer 6 obtained while the customer 6 is in or interacting with the DTOA 1. Additionally, system settings, functionality determinations, and current status information can be used to determine whether to initiate the process as an automated interaction or a manual one. Operations 202 through 206 illustrate several example factors or considerations that may be used to determine the appropriate mode to be used, and in response cause the switch's settings to be modified accordingly. Some, all, or alternative determinations can be used in different implementations.

At 202, a determination is made as to whether the switch 5 or any of the required components or aspects of the AOS 2 has power. If no power is available, then the switch 5 can route the interaction to the MOP 4 at 206, where a human agent can interact with the customer 6 to continue the transaction. If power is available, method 200 can continue at 203.

At 203, a determination is made as to whether the administrative controller 12 has been set to the automated management of interactions, either by default settings or manually by an authorized user. If set to automated, method 200 can continue to 204. If not, the interaction can be routed to the MOP 4 at 206.

At 204, a determination is made as to whether an existing connection to the AOS 2 meets a required or threshold quality. This determination can be performed automatically to determine whether the system can function properly based on the need for relatively high-speed or quality transmissions, even in light of the indication from the administrative controller 12 that the automated interface should be used. If the requisite quality of connection is available at the time the evaluation is performed, method 200 can continue at 205. If not, method 200 can route the interaction to the MOP 206.

At 205, one or more algorithms can be applied to determine whether the use of the AOS 2 is proper. These algorithms may be made available or assessed in the AOS 2, the administrative controller 12, or the switch 5, among others. Various real time or near real time data in terms of the current interaction can be evaluated, along with information from one or more remote or external data sources. The algorithms can be based on a set of conditional rules and/or optimization goals established by an administrator of the system, such as a manager, owner, or analyst, among others. The algorithms may use any suitable factors, which can include, but are not limited to, the absolute volume of transactions with customers in the DTOA 1 and/or inside the restaurant within a recent time period (e.g. in the prior 5 minutes, 15 minutes, etc.), the relative volume of transactions with customers in the DTOA 1 and/or inside the restaurant as compared to the typical transaction volume for that time of day and day of week, a current number of customers (or expected customers) in line to enter a DTOA 1, entering the DTOA 1, in line inside the restaurant, or entering the restaurant, the number of DTOAs 1 currently in use, the number of human agents currently available at the restaurant and a current number of transactions being performed inside of the restaurant, an estimate or determination of the availability or responsiveness of the human agents operating the MOP 4, and any other suitable operational metrics. Further, the determination of 205 may be based on information about the particular customer 6 associated with an interaction. If the customer 6 can be identified by a suitable system (e.g., a camera identifying a license plate associated with a particular known customer or customer profile, or a facial recognition system identifying the facial features of a particular customer), then information about prior interactions associated with the customer 6 can be used to determine an appropriate interaction type to be performed. If prior attempts at automated interactions have required a failover to a manual system, or failed to produce correct results after ordering attempts, then a customer-specific determination can be used to determine that a manual process should be initiated without attempting the automated interactions. Other customer-specific decisions can be used at 205 to determine how to route an incoming transaction.

If the switches 5 route the control of the ordering process to the restaurant's human agents, as shown in 206, then the local (or remote) human agents take drive-thru orders in the typical manual manner. The signal from the detector 7 can alert the human agent to the customer's presence and the human agents can manipulate the controls for the microphone 8, digital board 10, and/or speaker 9 to communicate with the customer 6 and manipulate the RIS 3 to transact the customer's order. This may be considered a typical drive-thru order process, although alternative manual operations can also be performed.

If, instead, each of the conditions 202 through 205 determine that the AOS 2 will initially interact with the customer 6, then the detector's signal can be provided to the AOS 2 via the connectors and switches 5 and cause the AOS 2 to initialize a new order session at 207.

At 207, the interaction is initialized by the AOS 2, which has primary administrative control of the DTOA equipment to begin the interactions. The AOS 2 can receive audio input from the microphone 8 and can provide output to be visually displayed by the digital board 10 or audibly emitted by the speaker 9. At 208, the AOS 2 manages the interactions after they have begun and processes the interactions based on the defined rules and procedures of the RIS 3 while interpreting and responding to customer input. The AOS 2 provides an initial voice prompt generated by the NLG to the customer through the speaker 9. The AOS 2 then processes the customer's voice response via the microphone 8 and the NLU. The ordering and conversation algorithms determine the AOS's next action based on the customer's response and continues to interact with the customer 6 through the ordering and interaction process. The AOS 2 will continue to interact with the customer 6 by processing the voice input from the customer 6 through the NLU, executing one or more actions by the ordering and conversation algorithms, and generating responses to the customer through the NLG and speaker 9 and/or through the digital board 10. The AOS 2 may process many rounds of interactions with the customer 6 to complete an order.

During the on-going interactions, the AOS 2 or another component can perform dynamic determinations related to the current interaction or particular system statuses to determine whether control should be transferred from the AOS 2 to the MOP 4. In some instances, the AOS 2 can automatically determine the transfer should occur, and can send a signal to the switch 5 or administrative controller 12 to route administrative control of the DTOA 1 equipment to the MOP 4 after the interactions have begun. Any number of suitable reasons for doing so may be considered on a real-time or running basis by the system to route the interactions to the human agent. Example dynamic considerations for re-routing the process that are evaluated during the transaction can include those of operations 209 through 213, although other considerations and evaluations can be considered and applied. Further, while operations 209 through 213 are illustrated sequentially, ongoing processes can consider the factors concurrently in part or in whole, or in a different order. In some instances, only some of the determinations may be monitored and considered by the AOS 2. Further, multiple checks and considerations can be considered, including multiple times throughout an interaction. For example, the determination of 209 may be performed multiple times in an interaction to ensure that the automatic ordering process can be handled successfully.

At 209, a determination can be made as to whether the microphone input from the customer 6 is useable, such as whether excessive background noise in the DTOA 1 degrades the performance of the NLU, or whether the customer 6 is unable to provide sufficient inputs for the DTOA 1 to be able to accurately evaluate the inputs. If satisfactory, method 200 continues to 210. If the input is not useable, method 200 can move to 214, where the transaction is re-routed to the MOP 4.

At 210, a determination is made as to whether the customer 6 is speaking or providing inputs in an unclear manner such that the performance of the NLU is degraded or unusable as a primary source of ordering determinations. If the input is sufficient, method 200 continues at 211, while if not, method 200 continues to 214.

At 211, a determination is made by the AOS 2 as to whether the monitored customer behavior is particularly unusual or negative. In some instances, the AOS 2 may identify emotional language or sentiments uttered by the customer 6 that are predetermined or derived signs of a negative or non-optimal interaction. In other instances, the AOS 2 may not be able to respond to otherwise intelligible speech because the subject matter of a customer's question or statement is highly atypical. In such instances, the interaction can be re-routed to the MOP 4 at 214.

At 212, a determination can be made as to whether the switch's connection to the AOS 2 has been lost or that that AOS 2 has experienced or identifies an internal error. The determination can be made by any suitable component, including the administrative controller 12, the switch's firmware, or the AOS 2 itself. In response to the detected error, control of the process can be automatically re-routed to the MOP 4 as needed.

At 213, a determination of whether human agents associated with the restaurant have interrupted the connection to the AOS 2 using the administrative controller 12 or by manually manipulating or interacting with the connectors or switches 5 can be made. The human agent also may manipulate the connectors or switches using voice commands through a microphone (such as a hands-free headset) that are processed by the AOS 2. In some instances, one or more human agents may be able to listen to the automated interactions with a customer. A voice queue, such as “I have this,” may be provided by a particular human agent when they would like to move the interaction to the manual system. In those instances, the voice queue can be received and used to trigger a move to the manual process. Any other suitable user interaction may cause the interruption as well. If so, operations can be re-routed to the MOP 4 at 214.

At 214, if an active ordering process with the AOS 2 is re-routed to MOP 4, then the human agents are alerted to the re-routed interaction and communicate with the customer 6 through the DTOA 1 equipment and can complete the order in the usual manual manner. Optionally, the AOS 2 may transmit to the RIS 3 information regarding the status of a re-routed order that was in process and/or may transmit to a human agent contextual information about the re-routed order status through natural language audio or text as generated by the AOS 2. In doing so, the human agent can be provided with a set of relevant contextual information that allows the human agent to immediately assist in and take over the interaction.

At 215, a determination can be made as to whether the particular customer 6 is known or is associated with transactional preferences or a customer profile. Customer-specific information maintained within or associated with the system can be used to identify the customer 6 in some instances. For example, the customer 6 may be identified using an artificial intelligence system operable to process an image captured by the camera 11 of the customer's license plate or vehicle, the microphone's input of the customer's voice, or an image captured by the camera 11 of the customer's face. In some instances, an RFID reader may be used or included in the detectors 7, and can be used to match an RFID-based transmission associated with the customer 6 (e.g., from an electronic toll device such as a TollTag or E-Z Pass, or from an automated parking device or card, among others). In some instances, business-specific identifiers can be provided, such as a customer-specific barcode or identified included on the customer's car that can be scanned by the camera 11 upon arrival at the DTOA 1. Alternatively, or in addition, the customer 6 may identify him or herself by providing a customer-specific code verbally, by entering information into an electronic device, or providing a customer-specific card or mobile application to an appropriate reader. In some instances, signals from a mobile device of the customer 6 can be used to identify the customer 6, including NFC, RFID, scanned images or values, or values received via a mobile app or message originating from the customer's mobile phone. If the customer 6 is identified at 215, method 200 continues at 216. If not, method 200 can continue at 217.

At 216, in response to customer 6 being identified, the AOS 2 may personalize the interaction with the customer based on stored information specific to the customer, such as prior transactions with the customer, profile information describing the customer or the customer's preferences, or the ordering behavior of other customer that are similar to the customer. The AOS 2 may personalize the interaction in a variety of ways, such as suggesting specific menu items to the customer, making reference to the customer's prior orders, or offering particular discounts to the customer 6.

At 217, a determination can be made whether a customer-specific reason to exit the AOS processing exists. The determinations at 216 may be similar to some of those described in 205, and may use preferences or prior interactions with the customer 6 to determine whether, after initializing the process 200 as an automated interaction, the later identification of the customer 6 requires the MOP 4 to take over. Again, such reasons may include customer-specific preferences, prior issues in obtaining accurate orders from the customer 6 in prior automated interactions, or any other suitable reason. If the re-routing is to occur, method 200 continues at 214 where the MOP 4 completes the interaction. If not, method 200 continues at 217, where the AOS 2 determines that the order is complete and can generate a response to the customer 6 with instructions on proceeding to pick up and/or pay for the ordered food and beverages. At 218, the AOS 2 transmits the order information to the RIS 3 so that the order can be fulfilled by the RIS 3 and the restaurant's human agents.

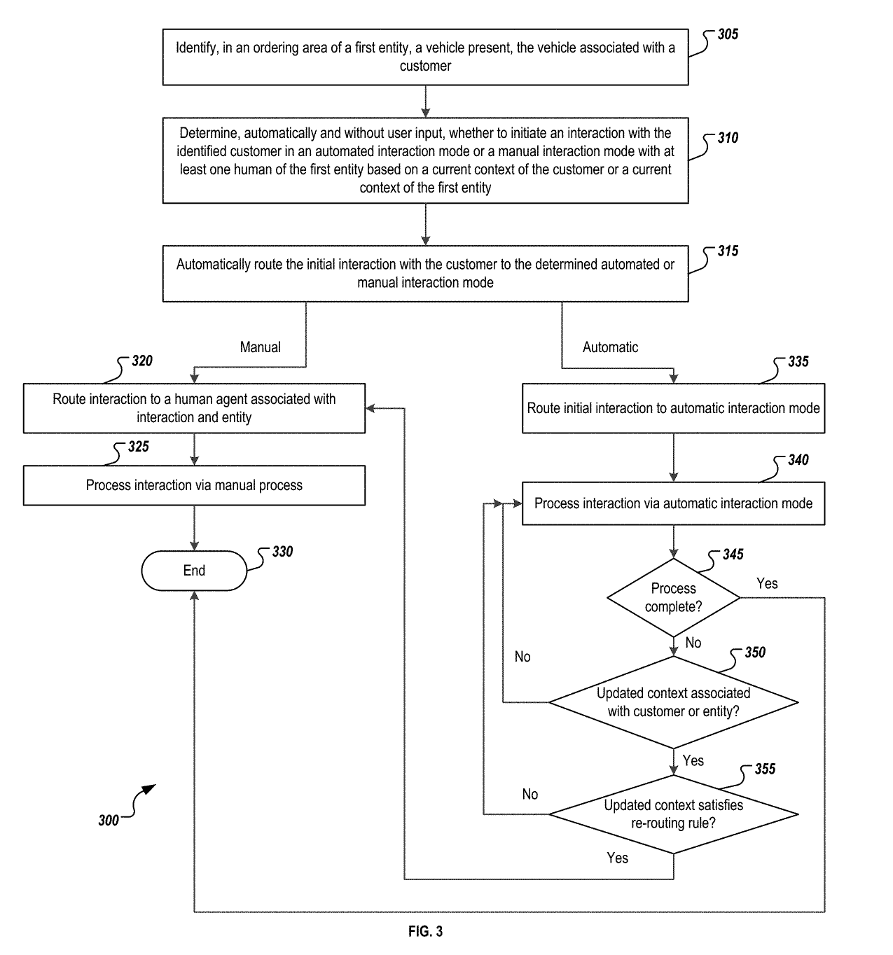

FIG. 3 is a flow diagram of an example method 300 for operating an automated ordering process in one implementation. It will be understood that method 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute method 300. In some implementations, the method 300 and related methods are executed by one or more components of the system 100 described above with respect to FIG. 1, or the components described in FIG. 2.

At 305, an identification of a vehicle present in an ordering area of a first entity can be made. The vehicle may be associated with a customer, such as an individual customer planning to interact with an ordering system. In some instances, no vehicle may be present, and the identification may instead be of a particular customer at the ordering area. In some instances as well, the ordering area may be a location for customer service interactions, where the ordering area represents a location at which a remote interaction system is available and where the customer can interact with an automated system or manually with a human agent at the location (e.g., via a telephony or telecommunications interaction, as well as via an in-person interaction). In some instances, information about the customer may be determined in response to the identification. The information may include, but is not limited to, an analysis of the vehicle (e.g., vehicle type, vehicle license plate, etc.), an analysis of the customer (e.g., an identity analysis, an initial sentiment analysis of vocal and/or facial interactions with the customer, etc.), or another analysis or interaction used to identify or obtain more information about the customer.

At 310, a determination can be made, automatically and without user input, whether to initiate the interaction with the customer in an automated interaction mode or a manual interaction mode. The automated interaction mode can be processed, for instance, by the AOS 2 of FIG. 1. The manual interaction mode can be performed or interacted using the MOP 4.

The initial determination can be based on a current context of the customer and/or the current context of the first entity. The current context of the customer may include or be based on the identification of the customer using any suitable analysis, including facial recognition (e.g., via a camera 11), voice recognition (e.g., via microphone 8), a vehicle license plate analysis and lookup (e.g., via camera 11), information obtained via a wireless connection to a customer device or via an app executing on a customer device, a method of customer identity input within the ordering area (e.g., a loyalty card or account identification or presentation, etc.), or any other suitable means. Once an identity is determined, information about that particular customer can be reviewed and analyzed to determine customer preferences, information about prior customer interactions (e.g., a success or failure rate of prior interactions with the same system), a relative complexity of prior orders and interactions with the customer, as well as other relevant information. Depending on an analysis of the initial customer context, a determination can be made whether to initiate an automated or manual ordering process.

Additionally or alternatively, the initial determination may be based on a context of the first entity. For example, the initial determination may be based on whether the AOS 1 is available (e.g., turned “on” by the entity) and/or functioning correctly at the time the interaction is to begin. In some instances, an analysis of a local or remote network connection may be performed to determine if signal quality from the ordering area to the AOS 2 and its systems exceeds a required signal quality and/or strength threshold. In some instances, the initial determination may be based on the availability of the human agents that operate the MOP 4, as those human agents may be occupied assisting other customers inside the restaurant or at another DTOA 1, performing other tasks, or otherwise unavailable. The availability of the human agents operating the MOP 4 may be determined based on the responsiveness of the human agents to initially engage with the customer at the DTOA 1. The determination may be based on a communication line to the human agent being in use, a determination that the human agent is involved in a current transaction, or on any other suitable determination made at or near the time of the customer interaction. In some instances, the number of ongoing interactions with other customers at the first entity may be used to determine the context of the first entity. The ongoing and/or expected interactions and transactions may be used in the determination, including a relative volume of transactions with customers in the DTOA 1 and/or inside the restaurant as compared to the typical transaction volume for that time of day and day of week, a current number of customers (or expected customers) in line to enter a DTOA 1, entering the DTOA 1, in line inside the restaurant, or entering the restaurant, the number of DTOAs 1 currently in use, the number of human agents currently available at the restaurant or at a remote location at which human agents interact with the customers, and a current number of transactions being performed inside of the restaurant, may each provide context to the determination.

At 315, the system can automatically route the initial interaction with the customer to the determined automated or manual interaction mode. When the manual interaction mode is selected, method 300 continues at 320, where the interaction is routed to a human agent associated with the interaction and associated with the first entity. In some instances, the human agent may be local to the interaction, and may interact through a speaker or other interactive interface associated with the first entity. In some instances, the manual process may result in an in-person interaction, or may direct the customer to a local human agent for in-person interactions. In other instances, the human agent may be remote from the interaction, such as at a remote call center, wherein the manual processing is performed via a telecommunications connection. At 325, the interactions can be processed via the manual process. Once complete, method 300 continues at 330, where method 300 ends.

Returning to 315, in response to determining that the automated interaction mode is to be used for the initial interaction, method 300 can continue at 335, where the initial interaction is routed to the automatic interaction mode. At 340, after routing the interaction, the interaction can be processed via the automatic interaction mode (e.g., via AOS 2 as described in FIG. 1). The determinations of 345, 350, and 355 can be performed on a periodic basis, in response to events, or continually throughout an interaction.

At 345, a determination can be made as to whether the process or interaction is complete. If so, method 300 can end at 330. If, however, the process continues, method 300 can continue to 350.

At 350, a determination can be made as to whether there is an updated context for either the customer or the entity, or both. The updated context may include any number of factors, and may include a technical or environmental issue associated with the automatic interaction, such as difficultly with a microphone or volume of an interaction being performed. If the automated process is not completing successfully, such as due to poor interactions or understanding of the customer, a new context may be associated. In some instances, the customer may only be positively recognized after the initial routing, and a personal preference may dictate a change to the manual process. In still other instances, a human agent may be able to listen in or otherwise follow an ongoing automatic interaction and can, at any time, interrupt the automatic interaction to move the interaction to a manual process (e.g., by providing a particular word or phrase via a headset such as “I've got this.”). Any other suitable analysis of an updated context can be performed. If such a change in context is not identified, method 300 can return to 340 and ongoing processing. If, however, a change in context is identified, method 300 continues at 355.

At 355, the updated context is analyzed to determine if the updated context satisfies a re-routing rule or threshold. In some instances, one error or a request for clarity during on automated interaction may not rise to a re-routing incident. However, multiple requests for clarity may cause the re-routing rule to be satisfied. Similarly, a short period (e.g., 1 second) of connectivity issues may not cause the re-routing to occur, but any further time may. If the re-routing rule is not satisfied based on the updated context, method 300 can return to the automatic processing of 340. If, however, the rule is satisfied, method 300 can perform a handover process from the automated interaction to a manual interaction, wherein the transition moves method 300 to 320 to complete the transaction in the manual process. In some instances, the automated system may send a set of information associated with the interaction as performed so far, such as a summary of instructions received, an identified issue causing the handover, or any other contextual information to the human agent. The set of information may include, for example, textual, visual, or audio information regarding the status of the interaction with the customer upon the re-routing of the interaction.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes, such as those in method 200, may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, Objective-C, JavaScript, Java™, Scala, Python, .NET, Visual Basic, assembler, Perl®, Swift, HTML5, any suitable version of 4GL, as well as others.

The system and methods described herein may be associated with a network that facilitates wireless or wireline communications between the components of the environment 100, as well as with any other local or remote computer, such as mobile devices, clients, servers, remotely executed or located portions of a particular component, or other devices communicably coupled to the network. The network may be a single network or may be comprised of more than one network without departing from the scope of this disclosure, so long as at least a portion of the network facilitates communications between senders and recipients. In some instances, one or more of the components may be included within network as one or more cloud-based services or operations. The network may be all or a portion of an enterprise or secured network, while in another instance, at least a portion of the network may represent a connection to the Internet. In some instances, a portion of the network may be a virtual private network (VPN) or an Intranet. Further, all or a portion of the network can comprise either a wireline or wireless link. Example wireless links may include 802.11a/b/g/n/ac, 802.20, WiMax, LTE, and/or any other appropriate wireless link. In other words, the network encompasses any internal or external network, networks, sub-network, or combination thereof operable to facilitate communications between various computing components inside and outside the described environment. The network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, and/or any other communication system or systems at one or more locations.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program or software can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/-R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for automatically interacting with a customer, the method comprising:
identifying a vehicle present in an ordering area of a first entity, the vehicle associated with a customer;
automatically and without user input determining whether to initiate an interaction with the identified customer in a first mode or a second mode, the first mode representing an automated interaction mode and the second mode representing a manual interaction with at least one human agent of the first entity, wherein the determination is based on at least one of a current context of the customer or a current context of the first entity; and
automatically routing the initial interaction with the customer to the determined first or second mode.

2. The method of claim 1, wherein the determined mode is the first mode, wherein the method further comprises, after initiating the interaction with the customer in the first mode:
dynamically determining an updated context associated with at least one of the customer or the first entity; and
re-routing the interaction with the customer to the second mode for further interactions based on the updated context.

3. The method of claim 2, wherein at least some of the human agents of the first entity are provided with textual, visual, or audio information regarding the status of the interaction with the customer upon the re-routing of the interaction.

4. The method of claim 2, wherein at least some of the human agents of the first entity are provided with textual, visual, or audio information regarding the status of the interaction with the customer during the interactions with the identified customer in the first mode.

5. The method of claim 2, wherein dynamically determining the updated context comprises identifying an interaction from at least one human agent associated with a re-routing instruction during an interaction with the identified customer while the initial interaction is being performed, and wherein, in response to the interaction from the at least one human agent, the interaction is re-routed to the second mode.

6. The method of claim 2, wherein dynamically determining the updated context associated with the at least one of the customer or the first entity comprises, after routing the initial interaction with the customer to the first mode:
determining an identification of the customer;
accessing a user profile associated with the identified customer; and
in response to determining that the user profile includes a preference for the second mode, re-routing the interaction with the identified customer to the second mode for further interactions.

7. The method of claim 2, wherein dynamically determining the updated context associated with the at least one of the customer or the first entity comprises determining, after routing the initial interaction with the customer to the first mode:
identifying a non-standard interaction with the customer via the automatic interaction mode; and
in response to identifying the non-standard interaction with the customer via the automatic interaction mode, re-routing the interaction with the identified customer to the second mode for further interactions.

8. The method of claim 1, wherein the determined mode for the initial interaction is the first mode, wherein the content of the automated interaction with the customer may be modified based upon contextual information specific to the customer or a generic profile of the customer.

9. The method of claim 1, wherein the determination is based on a current context of the customer, wherein the current context of the customer comprises an identification of a customer using at least one sensor associated with the ordering area of the first entity.

10. The method of claim 9, wherein the identification of the customer is based on a computer-based and automatic visual identification of the customer based on a license plate analysis of the vehicle.

11. The method of claim 9, wherein the identification of the customer comprises identifying a user profile associated with the customer, the user profile associated with a stored customer preference identifying an automatic or a manual interaction preference.

12. The method of claim 11, wherein the stored customer preference is based at least in part on at least one prior interaction with the first entity.

13. The method of claim 1, wherein the determination is based on a current context of the first entity, wherein the current context of the first entity comprises a technical analysis of a system associated with the automated interaction mode.

14. The method of claim 13, wherein, based on a result of a technical analysis of the system associated with the automated interaction mode, the initial interaction is automatically routed to the second mode.

15. A non-transitory, computer-readable medium storing computer-readable instructions executable by a computer and configured to:
identify a vehicle present in an ordering area of a first entity, the vehicle associated with a customer;
automatically and without user input, determine whether to initiate an interaction with the identified customer in a first mode or a second mode, the first mode representing an automated interaction mode and the second mode representing a manual interaction with at least one human agent of the first entity, wherein the determination is based on at least one of a current context of the customer or a current context of the first entity; and
automatically route the initial interaction with the customer to the determined first or second mode.

16. The computer-readable medium of claim 15, wherein the determined mode is the first mode, further configured to, after initiating the interaction with the customer in the first mode:
dynamically determine an updated context associated with at least one of the customer or the first entity; and
re-route the interaction with the customer to the second mode for further interactions based on the updated context.

17. The computer-readable medium of claim 16, wherein dynamically determining the updated context comprises identifying an interaction from at least one human agent associated with a re-routing instruction during an interaction with the identified customer while the initial interaction is being performed, and wherein, in response to the interaction from the at least one human agent, the interaction is re-routed to the second mode.

18. The computer-readable medium of claim 16, wherein dynamically determining the updated context associated with the at least one of the customer or the first entity comprises, after routing the initial interaction with the customer to the first mode:
determining an identification of the customer;
accessing a user profile associated with the identified customer; and
in response to determining that the user profile includes a preference for the second mode, re-routing the interaction with the identified customer to the second mode for further interactions.

19. The computer-readable medium of claim 16, wherein dynamically determining the updated context associated with the at least one of the customer or the first entity comprises determining, after routing the initial interaction with the customer to the first mode:
identifying a non-standard interaction with the customer via the automatic interaction mode; and
in response to identifying the non-standard interaction with the customer via the automatic interaction mode, re-routing the interaction with the identified customer to the second mode for further interactions.

20. A system comprising:
at least one processor;
a non-transitory computer-readable storage medium coupled to the at least one processor and storing programming instructions for execution by the at least one processor, the programming instructions instruct the at least one processor to:
identify a vehicle present in an ordering area of a first entity, the vehicle associated with a customer;
automatically and without user input, determine whether to initiate an interaction with the identified customer in a first mode or a second mode, the first mode representing an automated interaction mode and the second mode representing a manual interaction with at least one human agent of the first entity, wherein the determination is based on at least one of a current context of the customer or a current context of the first entity; and
automatically route the initial interaction with the customer to the determined first or second mode.
